(19) United States
(12) Patent Application Publication
(10) Pub. No.: US 2006/0002128 A1
(43) Pub. Date: Jan. 5, 2006

(54) Vehicle lighting apparatus

(75) Inventors: Eiji Suzuki, Isehara-shi (JP); Yasuhiro Ohkubo, Isehara-shi (JP)

Correspondence Address: FOLEY AND LARDNER LLP;SUITE 500, 3000 K STREET NW, WASHINGTON, DC, 20007, US

(73) Assignee: ICHIKOH INDUSTRIES, LTD.

(21) Appl. No.: 11/170,072

(22) Filed: Jun. 30, 2005

(30) Foreign Application Priority Data
Jun. 30, 2004 (JP) 2004-193058

(51) Int. Cl. F21V 1/00

(52) U.S. Cl. 362/509

(57) ABSTRACT

A vehicle lighting apparatus includes a bulb having a front end and a rear end; a reflector including an insertion hole for inserting the front end and a mounting portion to which the rear end is detachably mounted; and a reflective surface provided on the reflector, to reflect light from the bulb in a predetermined direction. The bulb is inserted in a direction intersecting with an optical axis so that a bulb axis intersects with the optical axis. The bulb axis is inclined in such a manner that the front end is declined towards a direction of reflection of the light by the reflective surface with respect to the rear end.

### CROSS-REFERENCE TO RELATED APPLICATIONS

The present document incorporates by reference the entire contents of Japanese priority document, 2004-193058 filed in Japan on Jun. 30, 2004.

### BACKGROUND OF THE INVENTION

1. Field of the Invention

The present invention relates to a vehicle lighting apparatus of a side-inserting bulb type, in which a bulb is fitted in a direction intersecting with an optical axis, and, more particularly, to a vehicle lighting apparatus by which an ideal light distribution pattern can be obtained from a near-infrared projector and a lamp for a low-beam distribution pattern, an the like.

2. Description of the Related Art

Conventionally, vehicle lighting apparatuses are of a longitudinal-inserting bulb type, in which the bulb is fitted in parallel to an optical axis, making a bulb axis parallel to the optical axis. However, in the conventional vehicle lighting apparatus, the insertion hole for the bulb is provided in a part of the reflective surface, which is closest to the bulb filament and which is a spot that can potentially reflect the light from the bulb most efficiently, thereby compromising the efficiency with which the light is reflected.

In view of this drawback, vehicle lighting apparatuses were developed that allowed the bulb to be fitted facing sideways. One such vehicle lighting apparatus is disclosed in Japanese Patent Laid-Open Publication No. 2000-82305. The vehicle lighting apparatus disclosed in Japanese Patent Laid-Open Publication No. 2000-82305 (hereinafter, “conventional vehicle lighting apparatus”) is described next. The conventional vehicle lighting apparatus includes a reflector plate and a reflective surface provided on the base. The reflector plate is provided with a bulb, a slot into which the bulb is inserted, and a lamp holder to which a mounting collar is detachably fitted. The reflective surface or a base member is attached to the reflector plate and directs the light from the lamp substantially parallel to as well in a predetermined direction with respect to the optical axis. In the conventional vehicle lighting apparatus, the direction of bulb insertion is at right angles with respect to the optical axis, disposing the lamp axis at right angles with respect to the optical axis.

The functioning of the conventional vehicle lighting apparatus is explained next. When the lamp is turned on, the base member directs the light from the lamp substantially parallel to as well as in a predetermined direction with respect to the optical axis. The spot on the base member which is closest to the lamp filament and which can potentially reflect the light most efficiently is used for producing reflected light. Therefore, the reflective surface or the base member in the conventional vehicle lighting apparatus is more efficient than in the vehicle lighting apparatus in which the bulb is fitted vertically. Furthermore, the conventional vehicle lighting apparatus is more compact compared to the vehicle lighting apparatus with a longitudinal-inserting bulb.

However, there are limitations to efficiently using the conventional vehicle lighting apparatus by having the light from the lamp reflected off the base member.

### SUMMARY OF THE INVENTION

It is an object of the present invention to at least solve the problems in the conventional technology.

A vehicle lighting apparatus according to one aspect of the present invention includes a bulb having a front end and a rear end; a reflector including an insertion hole for inserting the front end and a mounting portion to which the rear end is detachably mounted; and a reflective surface that is provided on the reflector, and reflects light from the bulb in a predetermined direction. The bulb is inserted in a direction intersecting with an optical axis so that a bulb axis intersects with the optical axis on a substantially horizontal cross section. The bulb axis is inclined in such a manner that the front end is declined towards a direction of reflection of the light by the reflective surface with respect to the rear end.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a vertical cross-section of a vehicle lighting apparatus according to a first embodiment of the present invention;

FIG. 2 is a cross-section cut along the line II-II shown in FIG. 1;

FIG. 3 is a view as seen from the line-III-III shown in FIG. 1;

FIG. 4 is a schematic for illustrating a reference luminous intensity distribution pattern, a near-infrared light distribution pattern, and a low-beam distribution pattern;

FIG. 5 is a horizontal cross-section illustrating an effective part of reflective surfaces that reflect light emitted from a bulb;

FIG. 6 is a horizontal cross-section illustrating the effective part of the reflective surfaces that reflect light emitted from the bulb in a conventional vehicle lighting apparatus;

FIG. 7 is a vertical cross-section of a vehicle lighting apparatus according to a second embodiment of the present invention;

FIG. 8 is a vertical cross-section of a vehicle lighting apparatus according to a third embodiment of the present invention;

FIG. 9 is a vertical cross-section of a vehicle lighting apparatus according to a fourth embodiment of the present invention; and

FIG. 10 is a vertical cross-section of a vehicle lighting apparatus according to a fifth embodiment of the present invention;

### DETAILED DESCRIPTION OF THE PREFERRED EMBODIMENTS

Exemplary embodiments of a vehicle lighting apparatus according to the present invention are explained below with reference to the accompanying drawings. It should be noted that the present invention is not limited to the present embodiments. In the present specification and drawings, the reference symbol “F” denotes “front” of a vehicle, the reference symbol “B” denotes “rear” of the vehicle, the reference symbol “U” denotes “upper side” in a case where the driver faces the front, the reference symbol “D” denotes “lower side” in a case where the driver faces the front, the reference symbol “L” denotes “left side” in a case where the driver faces the front, and the reference symbol “R denotes “right side” in a case where the driver faces the front. The reference symbol “VU-VD” denotes “vertical axis”, and the reference symbol “HL-HR” denotes “horizontal axis”.

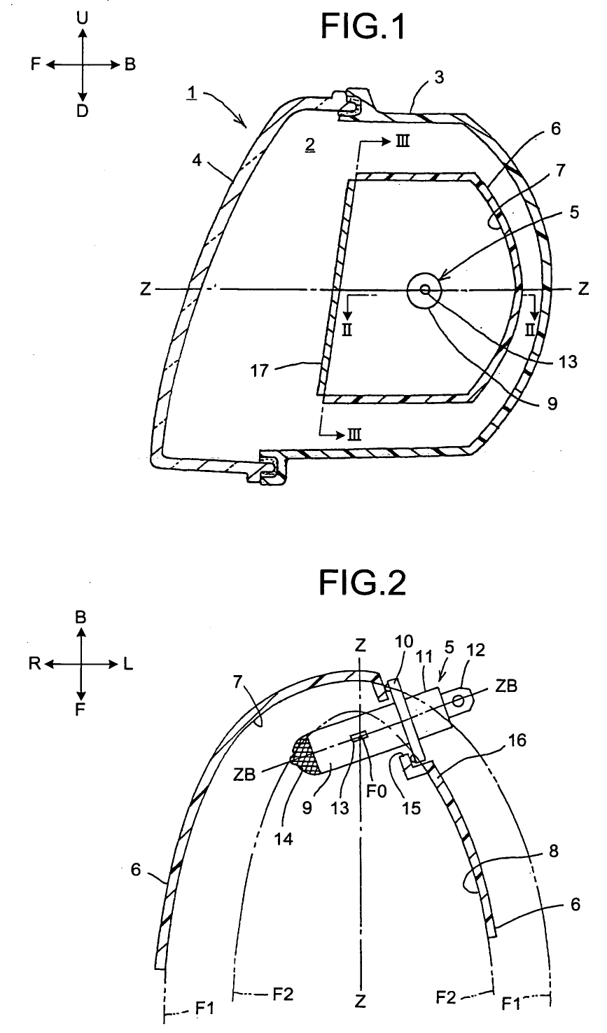

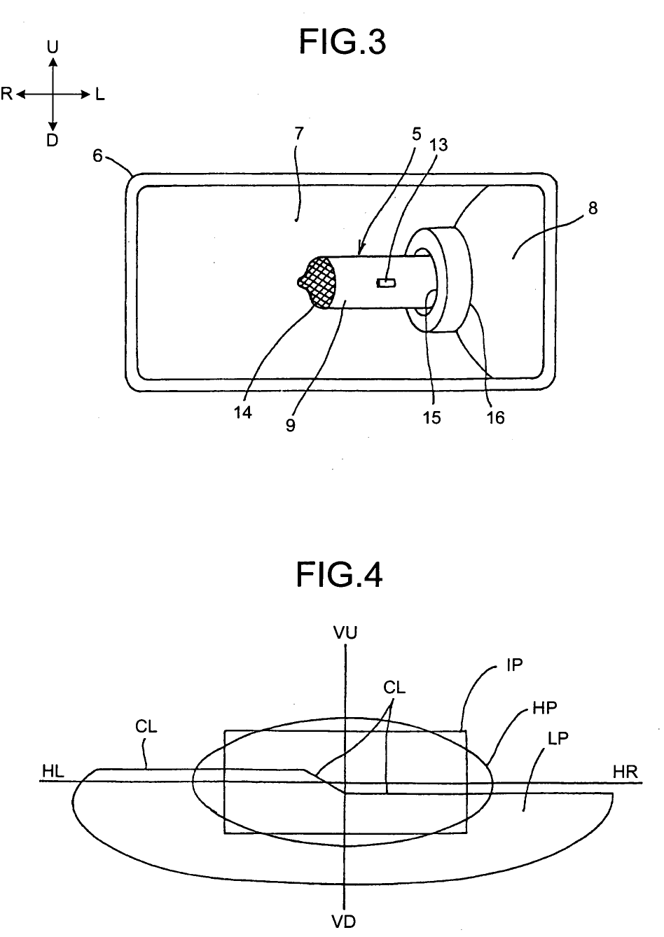

A first embodiment of the vehicle lighting apparatus according to the present invention is explained next with reference to FIG. 1 through FIG. 5. The structure of the vehicle lighting apparatus according to the first embodiment is explained first.

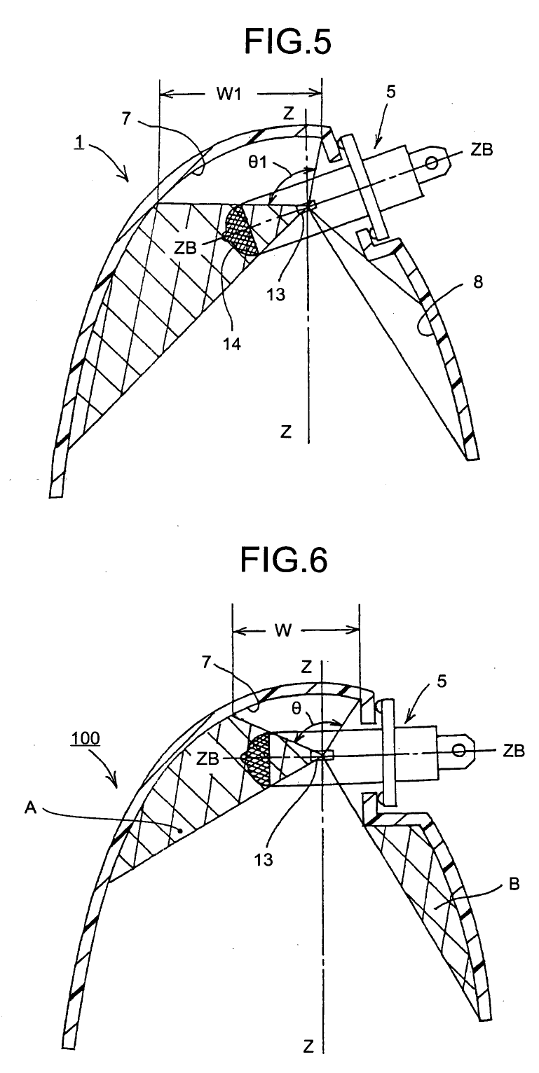

In FIG. 1 and FIG. 5, the reference number 1 denotes the vehicle lighting apparatus according to the first embodiment, the vehicle lighting apparatus being a near-infrared projector (or a near-infrared lamp or a near-infrared headlamp). As shown in FIG. 1, the near-infrared projector 1 includes a lamp housing 3 that sections off a lamp compartment 2, a lamp lens (outer lens) 4, a reflector 6 provided inside the lamp compartment 2, a light source in the form of a bulb 5 mounted on the reflector 6, reflective surfaces 7 and 8 provided on the reflector 6, and a filter 17 that lets infrared light get past.

The bulb 5 is a C-8 type halogen bulb and includes a glass bulb 9 at the front end, an attaching flange 10 at the rear end, a base 11, a connector 12, and a filament 13 provided within the glass bulb 9. The axis of the glass bulb 9 and the axis of the filament 13 coincide with the axis ZB-ZB of the bulb 5. The front end of the glass bulb 9 of the bulb 5 is blacked out to form a blackened top 14. The blackened top 14 prevents the light emitted from the front end of the filament 13 from scattering to the outside through the glass bulb 9. The prevention of scattering of the light emitted from the front end of the filament 13 by the blackened top 14 does not adversely affect the overall light emitted by the near-infrared projector 1 because the amount of light emitted from the front end of the filament 13 is negligible compared to the amount of light emitted from the sides of the filament 13.

The reflector 6 is mounted within the lamp housing 3 by means of a not shown optical axis adjusting mechanism. The reflector 6 has an insertion hole 15 into which the glass bulb 9 of the bulb 5 is inserted. The edge of the insertion hole 15 of the reflector has a bulb mounting portion 16 and a not shown mount mechanism on which the attaching flange 10 at the base of the bulb 5 detachably engages.

The reflective surfaces 7 and 8 include a main reflective surface 7 and a sub-reflective surface 8. The main reflective surface 7 is a paraboloid of revolution non-uniform rational B-splines (NURBS) curved surface or a NURBS curved surface based on the paraboloid of revolution (see, for example, Japanese Patent Laid-Open Publication No. 2001-35215) F1, and a sub-reflective surface 8, again, is a paraboloid of revolution NURBS curved surface or a NURBS curved surface based on the paraboloid of revolution F2. The optical axis Z-Z of the main reflective surface 7 and the optical axis Z-Z of the sub-reflective surface coincide. The focal point F0 of the main reflective surface 7 and the focal point F0 of the sub-reflective surface 8 coincide. The main reflective surface 7 and the sub-reflective surface 8 reflect the light emitted from the filament 13 substantially parallel to as well as in a predetermined direction with respect to an optical axis Z-Z. The focal distance of the sub-reflective surface 8 is shorter than the focal distance of the main reflective surface 7. The NURBS curved surfaces F1 and F2 are Non-Uniform Rational B-Spline Surface described in “Mathematical Elements for Computer Graphics” by David F. Rogers and J. Alan Adams.

The filter 17 is provided covering the opening of the reflector 6 and includes a light transparent base and an infrared light permeable film. The filter 17 permits the infrared component of the light emitted from the filament 13 of the bulb 5 of the halogen lamp to pass through while reflecting the visible component of the light. In other words, the filter 17 is permeable to infrared light but impermeable to visible light.

In the near-infrared projector 1, the bulb axis ZB-ZB is inclined at an angle with respect to the optical axis Z-Z in such a way that the glass bulb 9, which is the front end of the bulb 5, is oriented towards the direction of light reflection (towards the front F) by the main reflective surface 7 and the sub-reflective surface 8 as compared to the rear end of the bulb that includes the attaching flange 10, the base 11, and the connector 12. The filament 13 of the bulb 5 is located either at or close to the focal point F0 of the main reflective surface 7 or the sub-reflective surface. Further, because the direction of insertion of the bulb 5 intersects the optical axis Z-Z, the bulb axis ZB-ZB intersects the optical axis Z-Z on a substantially horizontal cross section.

The near-infrared projector 1 having the structure described above functions as a projector facilitating night vision. The near-infrared projector 1 is mounted in the front of a not shown vehicle along with a night vision imaging device meant for vehicles such as a charged-coupled-device (CC)D camera (not shown). The near-infrared projector 1 and the CCD camera together form a night vision device (a near-infrared night vision system for forward field of vision), which aids night driving.

When the filament 13 of the bulb 5 illuminates, the light from the filament 13 passes through all portions of the glass bulb 9 except from the blackened top 14 and the base portion, and gets reflected by the main reflective surface 7 and the sub-reflective surface 8. The light is reflected substantially parallel to the optical axis Z-Z as well as in a predetermined direction by the main reflective surface 7 and the sub-reflective surface 8. The reflected light then passes through the filter 17 and then through the lamp lens 4 as transmitted light. The light through the lamp lens 4 produces a near-infrared light distribution pattern IP as shown in FIG. 4. The reflected light only has the infrared component as the visible component of the light is blocked by the filter 17. Thus, an infrared night vision system can be realized by combining a CCD camera with the near-infrared projector 1 to aid night driving.

The light reflected by the main reflective surface 7 produces a light distribution pattern required for a night vision device, that is, a luminous light reaching far and covering a wide area. The light reflected by the sub-reflective surface 8 produces a light distribution pattern further required for fast driving, that is, a highly luminous light reaching far at a level in alignment with the center of the vehicle (towards VU of the vertical axis VU-VD shown in FIG. 4). The luminous and wide light distribution pattern obtained from the light reflected by the main reflective surface 7 and the highly luminous light distribution pattern obtained from the light reflected by the sub-reflective surface 8 combine to form a substantially rectangular near-infrared light distribution pattern IP with its long side along the horizontal axis HL-HR as shown in FIG. 4, which is an ideal light distribution pattern required on roads ranging from regular roads to highway fast lanes.

FIG. 5 is a schematic diagram of the vehicle lighting apparatus in the form of the near-infrared projector 1 according to the first embodiment. FIG. 6 is a schematic diagram of a conventional vehicle lighting apparatus 100.

As shown in FIG. 5, in the near-infrared projector 1, the bulb axis ZB-ZB is inclined at an angle with respect to the optical axis Z-Z. On the other hand, as shown in FIG. 6, in the conventional vehicle lighting apparatus 100, the bulb axis ZB-ZB is substantially orthogonal to the optical axis Z-Z. Thus, in the near-infrared projector 1, a solid angle θ1 formed by the light from the filament 13 of the bulb 5 incident on the part of the main reflective surface 7 that is closest to the filament 13 and that reflects the light most efficiently is greater than a solid angle θ of the conventional vehicle lighting apparatus 100.

Furthermore, in the near-infrared projector 1, an area W1 on the main reflective surface 7 up to the point where the light from the filament 13 becomes incident is wider than the corresponding area in the conventional vehicle lighting apparatus 100. In other words, a portion (the grid area A in FIG. 6) of the main reflective surface 7, rendered unusable by the blackened top 14 of the bulb 5 in the conventional vehicle lighting apparatus 100, can be effectively used in the near-infrared projector 1. As a result, in the near-infrared projector 1, the light from the bulb 5 is efficiently reflected by the main reflective surface 7.

Particularly, in the near-infrared projector 1, the bulb axis ZB-ZB is inclined at an angle with respect to the optical axis Z-Z in such a way that the glass bulb 9, which is the front end of the bulb 5, is oriented towards the direction of light reflection (towards the front F) by the main reflective surface 7 and the sub-reflective surface 8 as compared to the rear end of the bulb that includes the attaching flange 10, the base 11, and the connector 12. Consequently, in the near-infrared projector 1, the area (the grid area B in FIG. 6) near the bulb mounting portion 16 of the reflector 6 rendered unusable in the conventional vehicle lighting apparatus 100, is made available for providing an efficient sub-reflective surface 8. Thus, the near-infrared projector 1 can efficiently reflect the light from the bulb 5.

Thus, the near-infrared projector 1 according to the first embodiment produces the near-infrared light distribution pattern IP as shown in FIG. 4, which is an ideal light distribution pattern obtained by combining the light reflected by the main reflective surface 7 and the sub-reflective surface 8. As shown in FIG. 4, the area that is not illuminated by a reference luminous intensity distribution pattern LP, that is, the area above (in other words, further ahead of) a cut-off line CL of the reference luminous intensity distribution pattern LP, is illuminated by the near-infrared light distribution pattern IP. Therefore, the near-infrared light distribution pattern IP augments the illumination by the reference luminous intensity distribution pattern LP.

Further, in the near-infrared projector 1, the bulb 5, which is a C-8 type halogen lamp and has a substantially tubular glass bulb 9, and whose axis along with the axis of the similarly substantially tubular filament 13 coincides with the bulb axis ZB-ZB, is fitted facing sideways in the reflector 6. Consequently, the filament axis (which coincides with the bulb axis ZB-ZB) and the optical axis Z-Z of the main reflective surface 7 and the sub-reflective surface 8 are substantially orthogonal to each other on a substantially horizontal cross section. Thus, the near-infrared light distribution pattern IP, which is basically a magnification of the substantially rectangular (front elevation of the filament 13) filament 13, is produced by a simple structure.

Further, in the near-infrared projector 1, a C-8 type halogen bulb is used as the bulb 5, which strikes a balance between bulb life and light distribution characteristics (the characteristic near-infrared light distribution pattern IP). Consequently, the near-infrared projector 1 is best suited as a vehicle night vision projection device which augments the reference luminous intensity distribution pattern LP of the headlamp.

Further, in the near-infrared projector 1, the direction of bulb insertion intersects the optical axis Z-Z of the bulb 5 in a so-called side-inserting bulb type arrangement. Consequently, the size of the headlamp can be reduced in the optical axis Z-Z, making it ideal as a near-infrared projector.

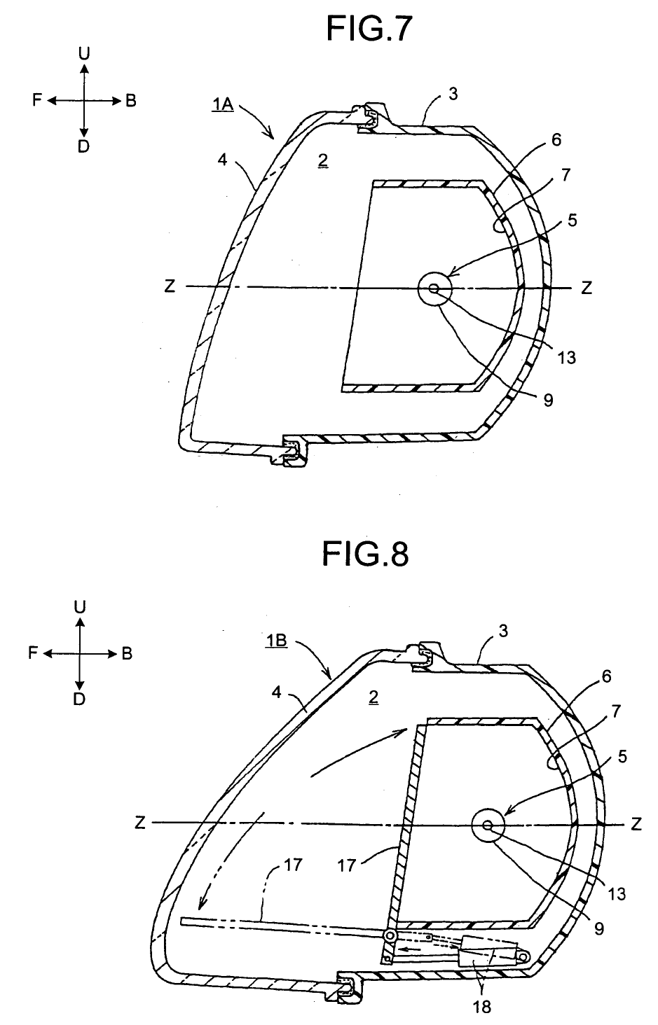

FIG. 7 is a vertical cross-section of a vehicle lighting apparatus according to a second embodiment of the present invention. The parts in FIG. 7 that are identical to those in FIG. 1 through FIG. 6 are assigned the same reference numerals.

The vehicle lighting apparatus 1A according to the second embodiment is a headlamp for driving and has a structure that is similar to the near-infrared projector 1 except that the filter 17 is absent.

Because of the way the vehicle lighting apparatus 1A according to the second embodiment is constructed, when the filament 13 of the bulb 5 illuminates, the light reflected by the main reflective surface 7 produces a light distribution pattern required for driving, that is, a luminous light reaching far and covering a wide area. Further, the light reflected by the sub-reflective surface 8 produces a light distribution pattern further required for fast driving, that is, a highly luminous light reaching far at a level in alignment with the center of the vehicle (towards VU of the vertical axis VU-VD shown in FIG. 4). The luminous and wide light distribution pattern obtained from the light reflected by the main reflective surface 7 and the highly luminous light distribution pattern combine to form a substantially rectangular or elliptical low-beam distribution pattern HP as shown in FIG. 4, which is an ideal light distribution pattern required for driving.

Thus, the vehicle lighting apparatus 1A according to the second embodiment realizes the effects substantially similar to those of the near-infrared projector 1.

A vehicle may be fitted with both the vehicle lighting apparatus 1A according to the second embodiment to serve as a headlamp and the near-infrared projector 1.

FIG. 8 is a vertical cross-section of a vehicle lighting apparatus according to a third embodiment of the present invention. The parts in FIG. 8 that are identical to those in FIG. 1 through FIG. 7 are assigned the same reference numerals.

The vehicle lighting apparatus 1B according to the third embodiment has a structure that is similar to the near-infrared projector 1 except that the filter 17 in the vehicle lighting apparatus 1B is rotatable with the aid of a cylinder or a solenoid 18 to cover or uncover the opening of the reflector 6.

Because of the way the vehicle lighting apparatus 1B according to the third embodiment is constructed, when the filament 13 of the bulb 5 illuminates in the state when the filter 17 is swiveled to close the opening of the reflector 6 by extending the cylinder or the solenoid 18, the ideal near-infrared light distribution pattern IP substantially similar to that produced by the near-infrared projector 1 is obtained. When the filament 13 of the bulb 5 illuminates in this state when the filter 17 swiveled back to uncover the opening of the reflector 6 by contracting the cylinder or the solenoid 18, as denoted by the chain double-dashed line in FIG. 8, the low-beam distribution pattern HP substantially similar to that produced by the vehicle lighting apparatus 1A according to the second embodiment is produced.

Thus, the vehicle lighting apparatus 1B according to the third embodiment realizes the effects substantially similar to those of the near-infrared projector 1 and the vehicle lighting apparatus 1A.

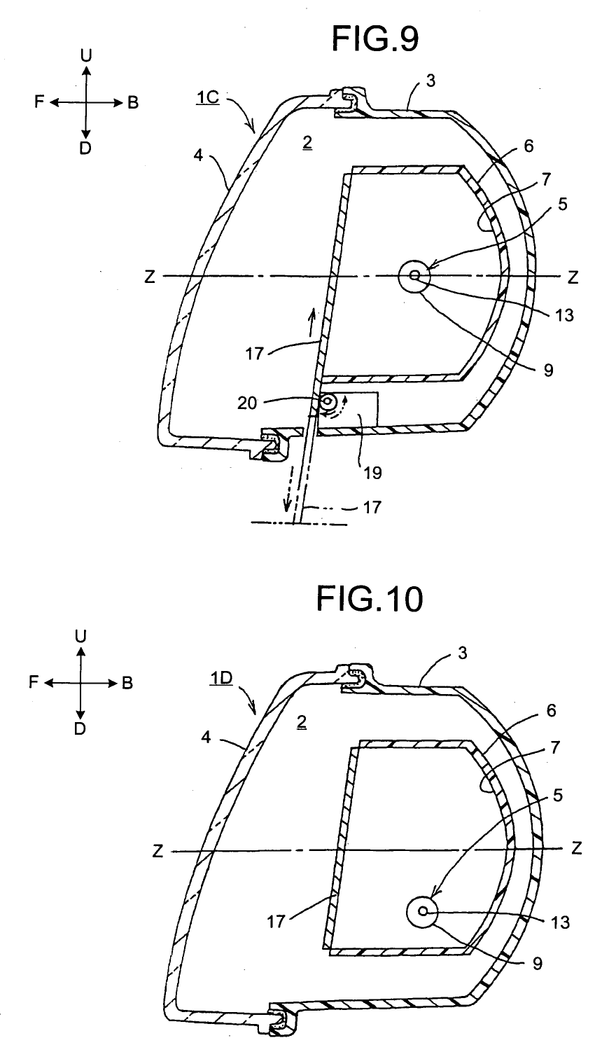

FIG. 9 is a vertical cross-section of a vehicle lighting apparatus according to a fourth embodiment of the present invention. The parts in FIG. 9 that are identical to those in FIG. 1 through FIG. 8 are assigned the same reference numerals.

The vehicle lighting apparatus 1C according to the fourth embodiment has a structure similar to the near-infrared projector 1 except that the filter 17 in the vehicle lighting apparatus 1C is slidable with the aid of a motor 19 and a rack-and-pinion mechanism 20 to cover or uncover the opening of the reflector 6.

Because of the way the vehicle lighting apparatus 1C according to the fourth embodiment is constructed, when the filament 13 of the bulb 5 illuminates in the state when the filter 17 is slid to close the opening of the reflector 6 by with the aid of the rack-and pinion mechanism 20 driven by the motor 19, the ideal near-infrared light distribution pattern IP substantially similar to that produced by the near-infrared projector 1 is obtained. When the filament 13 of the bulb 5 illuminates in the state when the filter 17 slid to uncover the opening of the reflector 6 with the aid of the rack-and-pinion mechanism 20 by the motor 19 driven in the reverse, as denoted by the chain double-dashed line in FIG. 9, the low-beam distribution pattern HP substantially similar to that produced by the vehicle lighting apparatus 1A according to the second embodiment is produced.

Thus, the vehicle lighting apparatus 1C according to the fourth embodiment realizes the effects substantially similar to those of the near-infrared projector 1 and the vehicle lighting apparatus 1A.

FIG. 10 is a vertical cross-section of a vehicle lighting apparatus according to a fifth embodiment of the present invention. The parts in FIG. 10 identical to those in FIG. 1 through FIG. 9 are assigned the same reference numerals.

The vehicle lighting apparatus 1D according to the fifth embodiment has a structure according to any of the vehicle lighting apparatuses 1, 1A, 1B, and 1C according to first through fourth embodiments except that the bulb 5 is located below the optical axis Z-Z.

Because of the way the vehicle lighting apparatus 1D according to the fifth embodiment is constructed, the light reflected from that spot in the main reflective surface 7 which is closest to the filament 13 of the bulb 5 and which can potentially reflect the light most efficiently is not blocked by the bulb 5. Consequently, in the vehicle lighting apparatus, the light from the bulb 5 is more efficiently utilized.

According to the present invention, a C-8 type halogen lamp is used as the light source, that is, the bulb 5. Other types of light source such as a discharge lamp, like an HID bulb, may also be used.

Furthermore, according to the present invention, the light source, that is the bulb 5, is fitted facing sideways from the left side with respect to the reflector 6. The bulb 5 may also be fitted facing sideways from the right side with respect to the reflector 6.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle lighting apparatus comprising:
a bulb having a front end and a rear end;
a reflector including
an insertion hole for inserting the front end; and
a mounting portion to which the rear end is detachably mounted; and
a reflective surface that is provided on the reflector, and reflects light from the bulb in a predetermined direction, wherein
the bulb is inserted in a direction intersecting with an optical axis so that a bulb axis intersects with the optical axis on a substantially horizontal cross section, and
the bulb axis is inclined in such a manner that the front end is declined towards a direction of reflection of the light by the reflective surface with respect to the rear end.

2. The vehicle lighting apparatus according to claim 1, wherein the reflective surface includes
a main reflective surface that is formed with a paraboloid of revolution or a non-uniform rational B-splines curved surface with a first focal distance; and
a sub-reflective surface that is disposed around the mounting portion, and is formed with a paraboloid of revolution or a non-uniform rational B-splines curved surface with a second focal distance that is shorter than the first focal distance.

3. The vehicle lighting apparatus according to claim 1, wherein the bulb is a C-8 type halogen lamp consisting of a glass bulb with a blackened top portion.

4. The vehicle lighting apparatus according to claim 1, further comprising a filter that reflects visible light component and passes infrared light component from the light reflected by the reflective surface.

5. The vehicle lighting apparatus according to claim 1, further comprising a filter that reflects visible light component and passes infrared light component from the light reflected by the reflective surface, wherein
the filter is openably and closably provided on an optical path of the light reflected, and
closing of the filter obtains infrared light, and opening of the filter obtains visible light.

6. The vehicle lighting apparatus according to claim 1, wherein the bulb is disposed below the optical axis.
